(19) United States
(12) Patent Application Publication
(10) Pub. No.: US 2007/0116313 A1
(43) Pub. Date: May 24, 2007

(54) Electro-acoustic Sound Diffuser

(76) Inventor: Robert Douglas Seagrove, Rockwood (CA)

Correspondence Address: Robert D. Seagrove, 14175 4th Line Nassagaweya RR#2, Rockwood, ON, N0B2K0, CA

(21) Appl. No.: 11/467,558

(22) Filed: Aug. 27, 2006

(30) Foreign Application Priority Data
Jul. 5, 2005 (CA) 2,511,401

(51) Int. Cl. H04R 1/20

(52) U.S. Cl. 381/337; 381/339

(57) ABSTRACT

Electro-acoustic Sound Diffuser in the form of a loudspeaker fitted with at least one driver powered by means of acceptable input signal; in proximity to at least one rotatable baffle which bear perforations and artwork; driven by an electric motor; means to control motor, for the purpose of modifying, altering, coloring a typical sound generated by a musical instrument, microphone, device or apparatus.

### FIELD OF THE INVENTION

1. This invention relates to musical instrument electro-acoustic transducers, their enclosures and related elements.

### BACKGROUND OF THE INVENTION AND RELATED ART

1. The *Electro-acoustic Sound Diffuser relates to a physical method of modifying, altering, coloring, a nominally normal audio signal propelled by audible energy generated by at least one electro-acoustic transducer receiving an input signal.

The Electro-acoustic Sound Diffuser produces a unique sound unlike any other. It is also a visual experience to an onlooker.

The Baffle (4) fitted with Perforations (5) is driven directly by an electric motor (6) which is hidden between the baffle (4) and loudspeaker driver (2) said motor (6) fixed to the enclosure (10) by means of a frame (8) and connecting apparatus, is capable of rotating the baffle (4). The speed of the electric motor (6) is controlled by an electric motor speed control (12) fixed to the Enclosure (10) and connected by internal wiring (24) or remotely connected by means of a removable cable (22).

A signal from instrument or apparatus to amplifier, input to the * sound diffuser at the required impedance and voltage to the loudspeaker driver propels airborne sound waves towards the baffle (4).

When the baffle (4) is in a fixed position the *Sound Diffuser functions as an altered close field omnipresent loudspeaker. Sound energy is diffused into the air and baffle (4) which resonates producing harmonics and the altered sound also makes its way through arranged perforations (5). When the baffle (4) is set into rotation mode the sound waves are sliced by protected edges beared by perforations in the Baffle (4). The baffle (4) adds harmonics and chorusing effect which are proliferated by rotation. Frequencies from approximately 65 Hz to 20 khz are experienced.

4. Model (A3) Baffle is a modified wheel cover (5).

References Cited:
CA1120972 Marshall, Claude J., Jr. Mar. 28, 1979
   We have modified the wheel cover from its original state as claimed in 6. model A3. The baffle has been tuned and balanced with extra baffle elements within to achieve a required sound.

The Electro-acoustic Sound Diffuser is designed mainly for use as an alternative musical instrument loudspeaker and may also be used for microphone or other compatible input device with a view of intent to color the original sound.

Disclosed variations of this invention do not limit the boundries of undisclosed variations for the future life of this file.

### LIST OF DRAWINGS

FIG. 1. Representative perspective drawing.

FIG. 2. Front View.

FIG. 3. Section Drawing.

FIG. 4. Front View model A2.

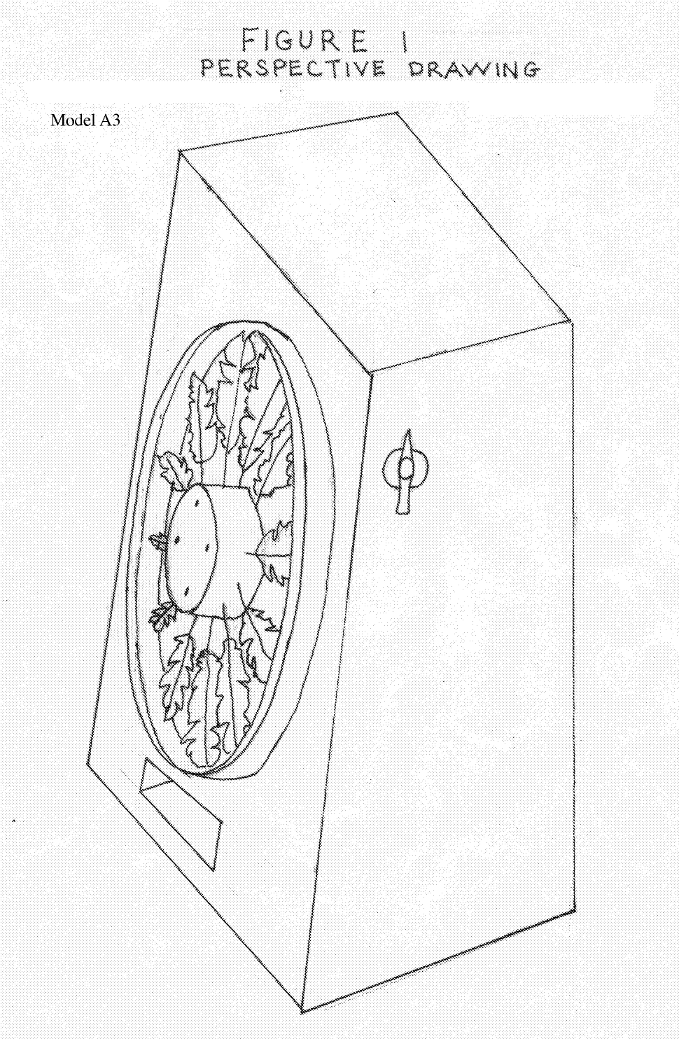

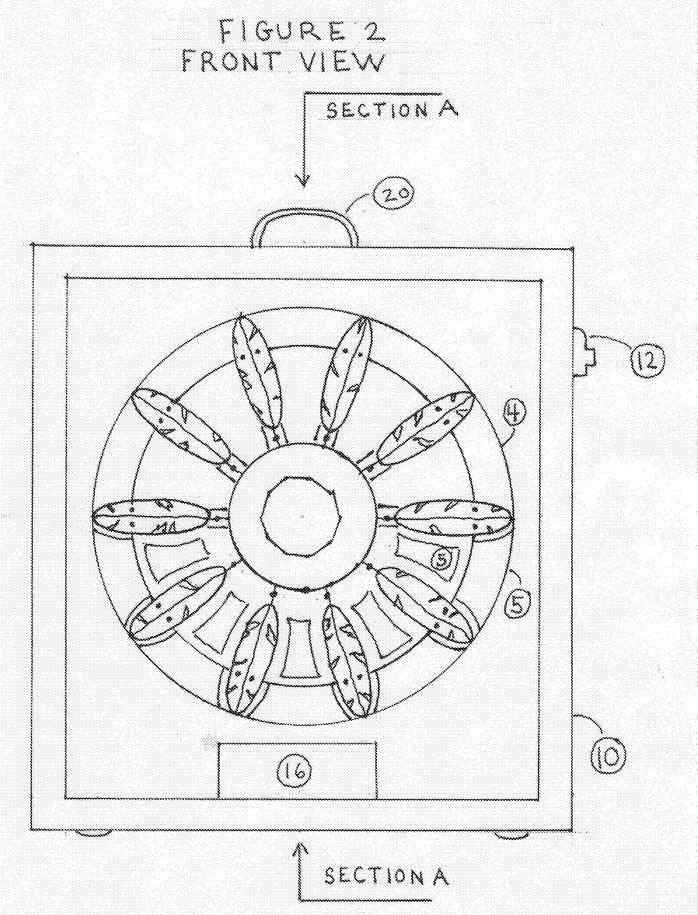

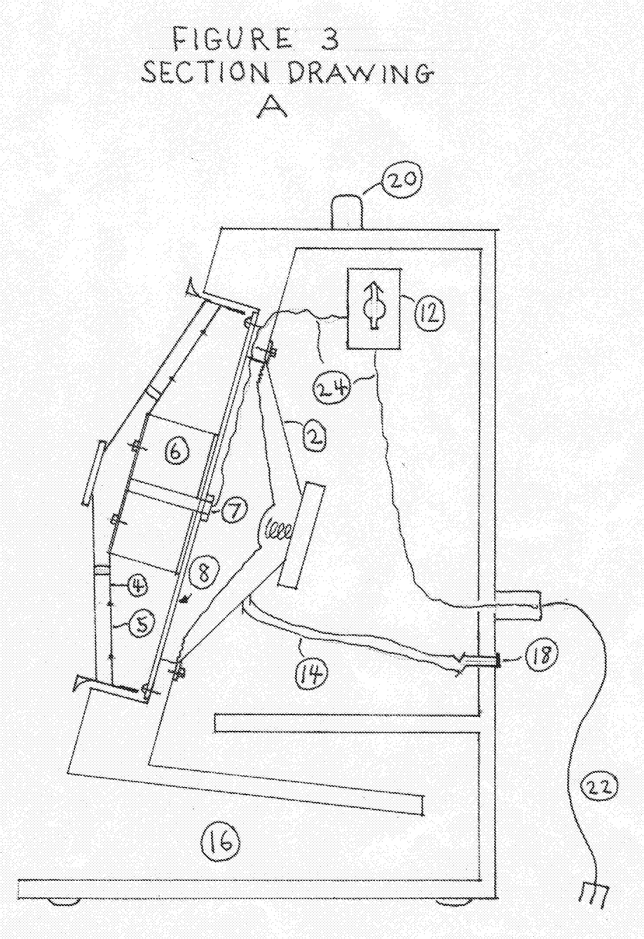

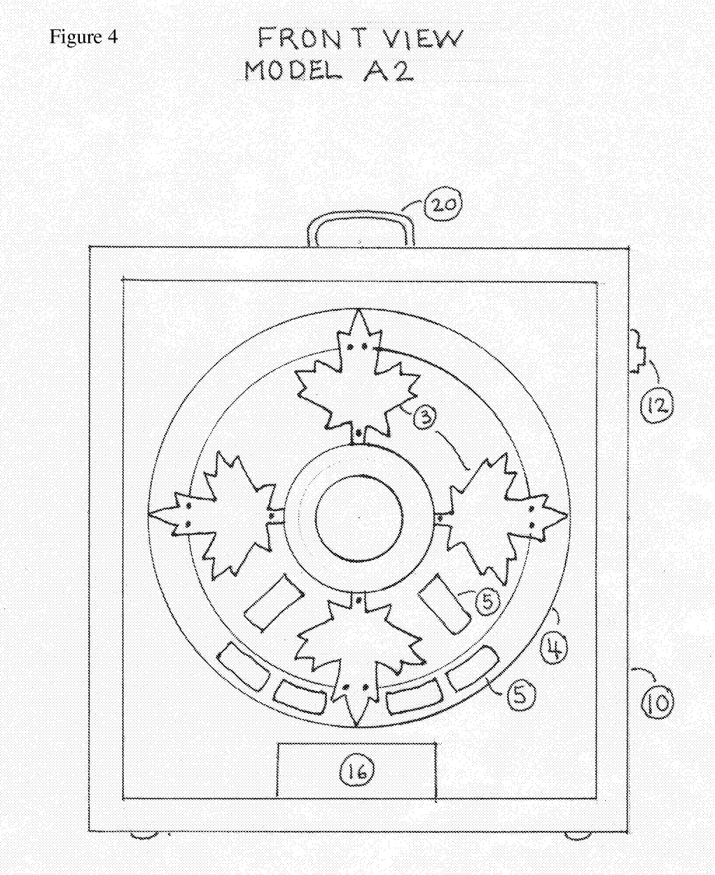

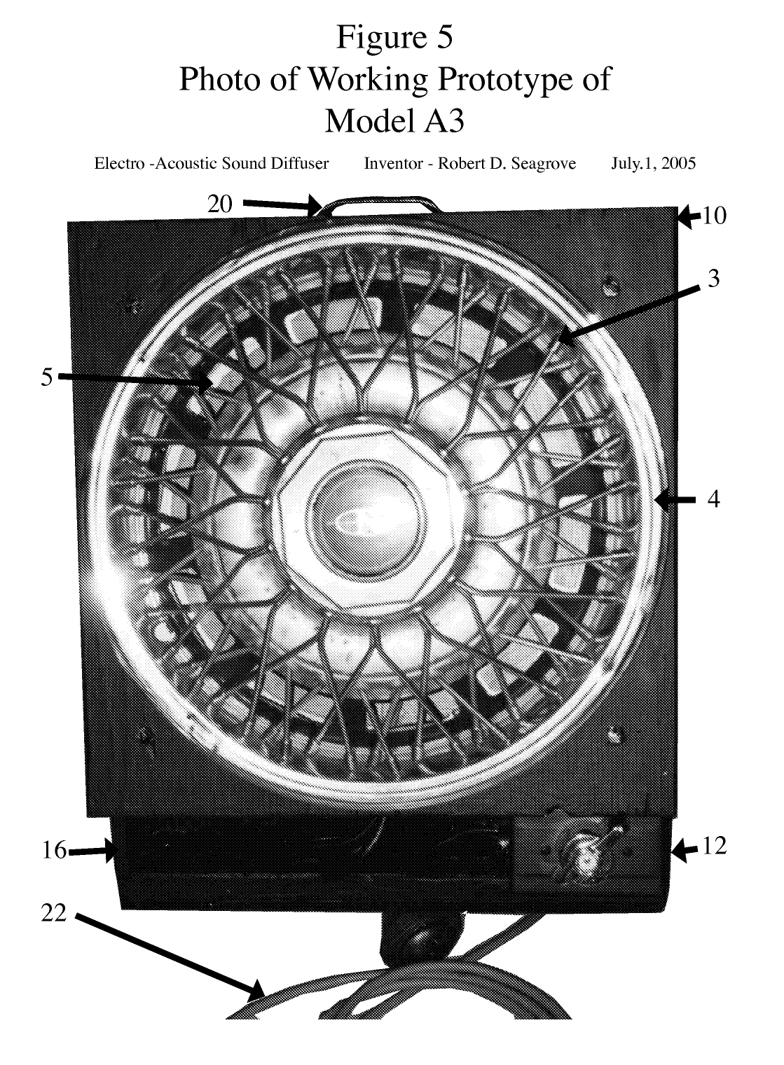

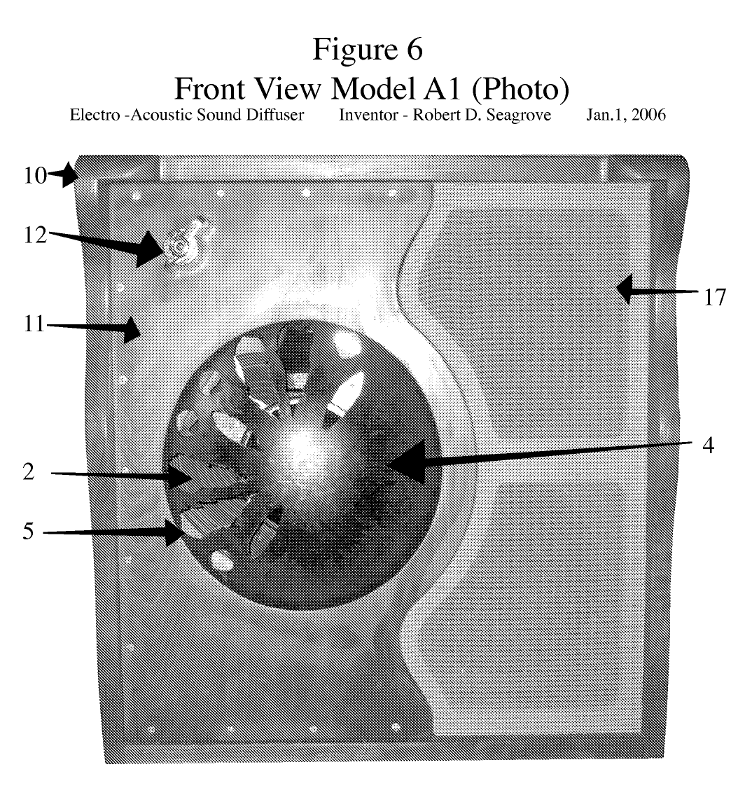

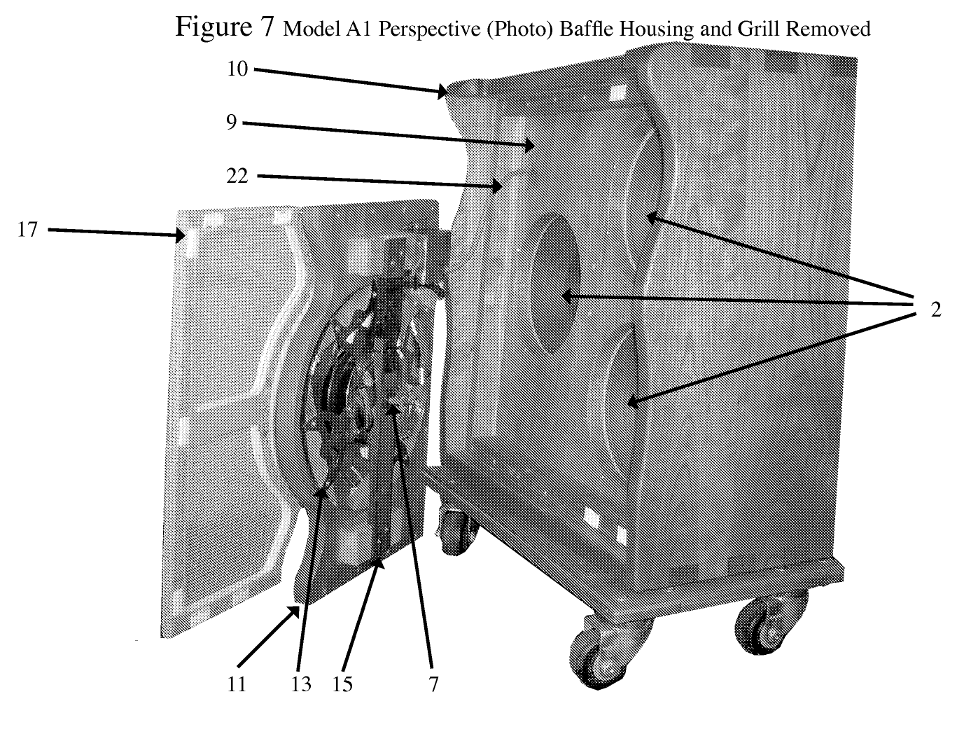

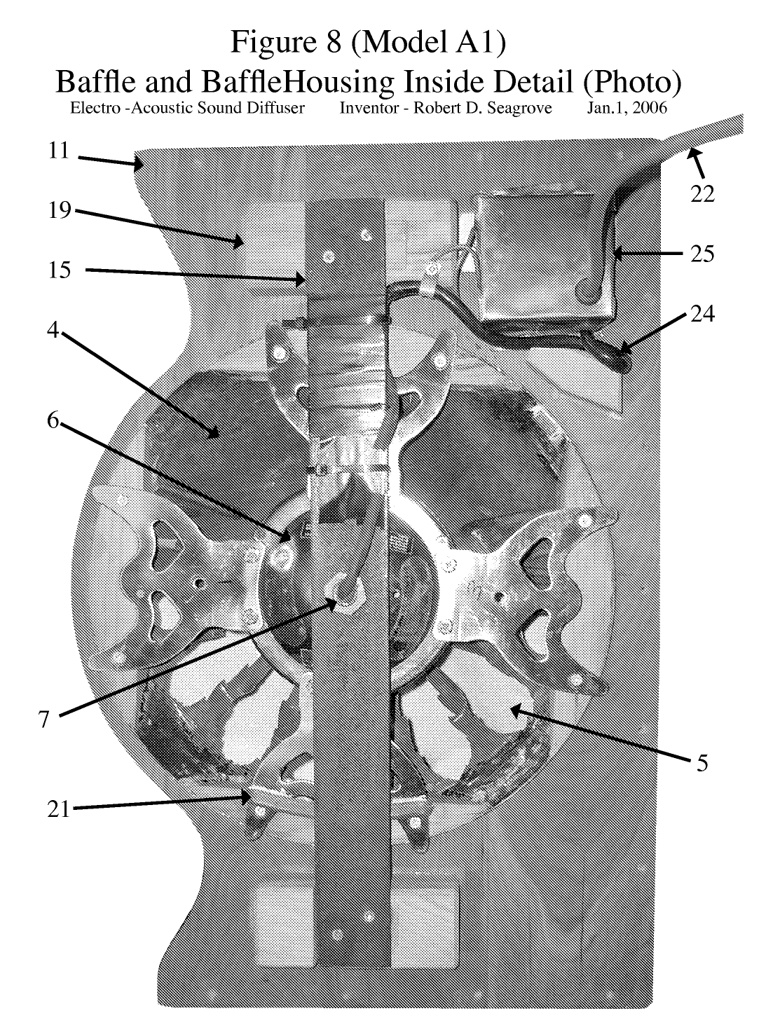

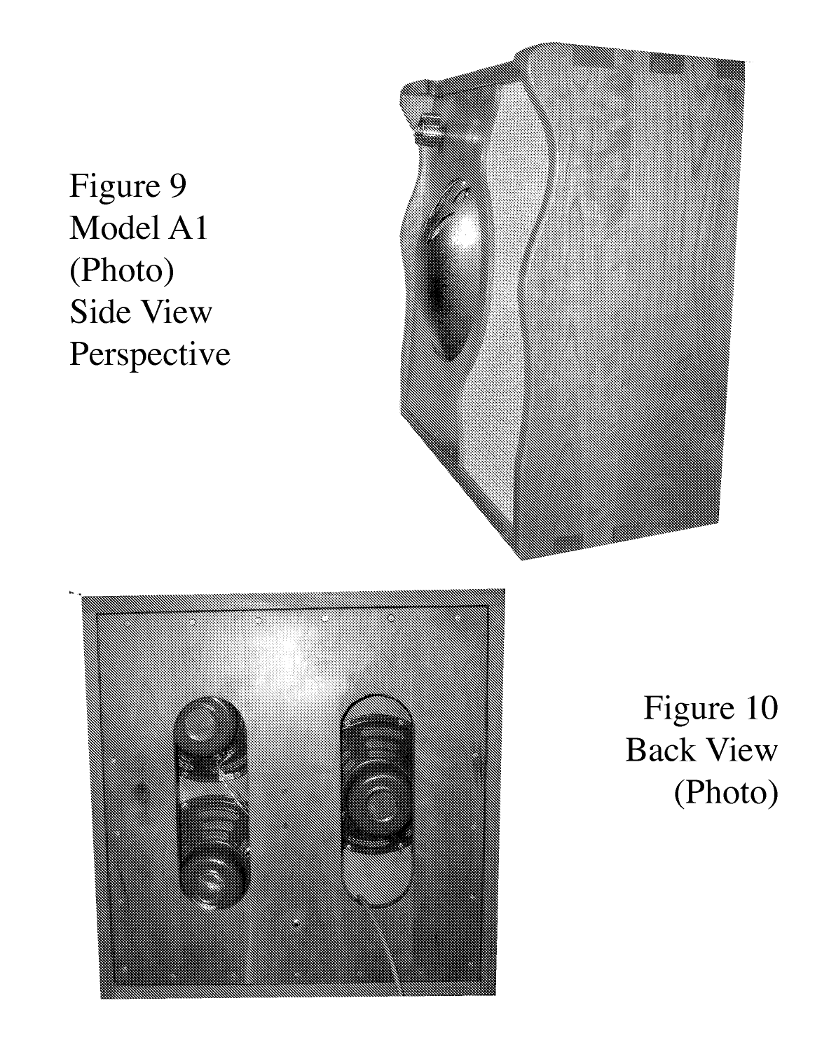

### LIST OF PHOTOGRAPHS

FIG. 5. Photo of working prototype of model A3.

FIG. 6. Front View Model A1 (Photo)

FIG. 7. Model A1 Perspective (Photo) Baffle Housing and Grill Removed

FIG. 8. (Model A1) Baffle and Baffle Housing Inside Detail (Photo)

FIG. 9. Model A1 (Photo) Side View Perspective

FIG. 10. Back View (Photo)

### ELEMENTS AND CORRESPONDING NUMBER

2. Loudspeaker driver

3. Soldiers

4. Baffle

5. Perforations

6. Electric Motor

7. Axle

8. Frame

9. Model A Loudspeaker Baffle

10. Enclosure

11. Model A1 Baffle Housing

12. Speed Control

13. Baffle to Motor Mount

14. Speaker Signal Supply Wire

15. Motor axle Mount Bracket

16. Folded bass reflex horn

17. Grill

18. Input Jack

19. Baffle Assembly to Baffle Housing Mount

20. Handle

21. Balance Weight

22. Cable for Electric Motor remote control

24. Motor Power Supply Wire

25. Speed Control Cover

The embodiments of the invention in which an exclusive property or privilege is claimed are defined as follows:

1. Electro-acoustic Sound Diffuser comprising,
at least one loudspeaker driver mounted in an enclosure; at least one rotatable baffle fitted with perforations; mounted on the axis of a variable speed electric motor; which is mounted on a frame and fastened to the enclosure in proximity to the loudspeaker driver; an electric motor speed control to control the rotation speed of the baffle.

2. Electro-acoustic Sound Diffuser of claim 1, wherein said enclosure, is fitted with a folded horn assembly yielding lower frequency soundwaves generated from the rear of the loudspeaker driver.

3. Electro-acoustic Sound Diffuser of claim 1, is fitted with at least one baffle fitted with perforations to be fastened in proximity to the folded horn assembly.

4. Model (A3) Electro-acoustic Sound Diffuser of claim 1, wherein said baffle fitted with perforations is substituted with a modified wheel cover (5)X.
